(19) United States
(12) Patent Application Publication
(10) Pub. No.: US 2008/0083868 A1
(43) Pub. Date: Apr. 10, 2008

(54) Monitoring devices and surveillance devices

(75) Inventors: Torsten Wipiejewski, Hong Kong (CN); Yeung Ming Chow, Hong Kong (CN)

Correspondence Address: BUCHANAN, INGERSOLL & ROONEY PC, POST OFFICE BOX 1404, ALEXANDRIA, VA, 22313-1404, US

(73) Assignee: Hong Kong Applied Science and Technology Research Institute Co. Ltd., Hong Kong (CN)

(21) Appl. No.: 11/453,829

(22) Filed: Jun. 16, 2006

(51) Int. Cl. G06M 7/00

(52) U.S. Cl. 250/221

(57) ABSTRACT

A monitoring device for security surveillance application, the device comprising:
an electromagnetic wave sensor for sensing electromagnetic wave from an external electromagnetic wave source;
a detection window for forming a partition between the external electromagnetic wave source and the electromagnetic wave sensor; and
an anti-tampering arrangement comprising an optical arrangement for deploying an optical surveillance beam and control circuitry, wherein
   i. the optical surveillance beam comprising a first beam portion and a second beam portion, the first beam portion being a beam emitted by the optical arrangement towards the detection window and the second beam portion being due to total internal reflection of the first beam portion by the detection window, and
   ii. the control circuitry being for detection of a variation of the second beam portion, wherein the variation is indicative of tampering of the detection window.

### FIELD OF THE INVENTION

This invention relates to monitoring devices and, more particularly, to monitoring devices with for surveillance applications. More specifically, this invention relates to surveillance apparatus such as intrusion detectors, especially surveillance detectors with an infra-red detector. This invention also relates to surveillance devices incorporating electromagnetic sensors, such as infra-red sensors.

### BACKGROUND OF THE INVENTION

Monitoring devices comprising electromagnetic wave (EM-wave) sensors are particularly useful in surveillance applications. For example, intrusion detectors comprising PIR (passive infra-red) sensors are commonly deployed in homes, museums, banks, offices, and other commercial and/or industrial establishments for security surveillance. Such intrusion detectors usually operate to detect infra-red (IR) radiation radiated by a moving object and will trigger an alarm when the detected IR level exceeding a pre-determined threshold, corresponding to the detection of an approaching or intruding human being. It is known that living objects emit IR radiation at a wavelength of about 10-12 μm. The more sophisticated IR detectors are equipped with processing circuitry to distinguish between an approaching human body or other living bodies. Intrusion monitoring devices are frequently subject to tampering by intruders or by vandalism. Intruders have been known to apply a mask of lacquer, which is opaque to IR radiation, onto the detection window of an intrusion window to cheat it. Hence, it will be beneficial if there can be provided improved EM-wave detectors, especially IR monitoring devices alleviating shortcomings of conventional devices.

### SUMMARY OF THE INVENTION

Accordingly, this invention has described monitoring devices for security surveillance application, the device comprising an electromagnetic wave sensor for sensing an electromagnetic wave of an external electromagnetic wave source; a detection window disposed between said external electromagnetic wave source and said electromagnetic wave sensor; and an anti-tampering arrangement, wherein the anti-tampering arrangement comprises an optical arrangement for deploying an optical surveillance beam in which an optical monitoring loop or circuit is cooperatively formed by total internal reflection at the detection window. The closed loop optical monitoring circuit comprises an optical loop which is maintained by total reflection of a surveillance beam when the monitoring device is under normal conditions. When the detection window has been tampered, the optical loop of the surveillance beam will be broken. Therefore, an alarm signal corresponding to a tampered condition could be generated upon detection of a broken optical loop.

In a preferred embodiment, the optical arrangement comprises a control circuitry and the optical surveillance beam comprises a first beam portion and a second beam portion, said first beam portion being a beam emitted by said optical arrangement towards said detection window, and said second beam portion being due to total internal reflection of said first beam portion by said detection window, and said control circuitry being for detection of a variation of said second beam portion, wherein the variation is indicative of tampering of said detection window.

When the detection window is tampered, for example, by applying a transparent lacquer mask which is IR shielding on the external surface of the detection window of the monitoring detector, the refractive characteristics of the detection window will be altered. For example, the refractive gradient between the detection window and the outside space will be changed so that the surveillance loop due to total internal reflection is disrupted. By the deployment of such an optical surveillance beam within the monitoring device, tampering of the detection window will be readily detected by monitoring the variation in the level of the detected optical surveillance beam, which is indicative of a change in the refractive characteristics or the refractive gradient of the detection window. The control circuitry can be arranged to generate an alarm signal upon detection of an abnormal variation in the level of the detected surveillance beam.

As an exemplary arrangement, the control circuitry is for monitoring electrical output of the optical detector, a variation in electrical output of the optical detector is indicative of a variation in the refractive characteristics of said detection window and being indicative of tampering of said detection window. Upon detection of a variation indicative of tampering, the control circuitry will send or cause to send an alarm signal.

In a preferred embodiment, the detection window is forward of the optical arrangement so that the optical arrangement comprising an optical source and an optical detector is kept behind the detection window and not accessible from the outside. Specifically, the optical source is aligned for emitting an optical surveillance beam forwardly towards the detection window and the optical detector is aligned for detecting the optical surveillance beam after it has undergone total internal reflection upon encountering the detection window. In addition, the control circuitry is for monitoring electrical output of said optical detector.

When the detection window has been tampered by the coating or masking of a layer of lacquer or other tampering substances, the refractive characteristics of the detection window as characterised by the critical angle of the detection window will be altered. As a result of the change in the critical angle, the surveillance beam no longer undergoes total internal reflection upon incident on the detection window and the optical surveillance beam is interrupted. Such an interruption will be detected by the control circuitry will generate appropriate alarm signals to alert security.

As the optical arrangement is contained within the monitoring device, the operational characteristics of such an anti-tampering arrangement are not readily apparent to an intruder and the application of conventional masking techniques to tamper the monitoring device will not succeed.

Preferably, the optical source, the detection window and the optical detector are arranged whereby an optical surveillance beam emitted by the optical source is diverted towards the optical detector by total internal reflection upon encountering with the detection window.

Preferably, said detection window is positioned forward of said optical arrangement; the optical arrangement of said anti-tampering arrangement comprises an optical source for emitting an optical surveillance beam forwardly towards said detection window, and an optical detector for detecting said surveillance beam after undergoing total internal reflection upon encountering said detection window; and said control circuitry providing for monitoring electrical output of said optical detector, and a variation in electrical output of said optical detector being indicative of a variation in the optical refractive characteristics of said detection window and being indicative of tampering of said detection window.

Preferably, said control circuitry is further monitoring of electrical output from said optical detector, and wherein a variation in electrical output of said optical detector is indicative of a variation in the refractive characteristics or refractive gradient of said detection window and is indicative of tampering of said detection window.

Preferably, said optical source, said detection window and said optical detector are arranged such that an optical surveillance beam emitted from said optical source is diverted towards said optical detector by total internal reflection upon encountering said detection window.

Preferably, said control circuitry comprises a control means for monitoring electrical output of said optical detector, said control means generating an alarm signal when electrical output from said optical detector exceeds a predetermined threshold level.

Preferably, said detection window is transparent to both said electromagnetic wave and said optical surveillance beam.

Preferably, said electromagnetic wave is infrared and the electromagnetic wave sensor comprises a passive infrared sensor.

Preferably, said optical source comprises a laser transmitter for emitting a laser surveillance beam and the optical detector comprises a photo-detector for detecting said laser surveillance beam.

Preferably, said laser transmitter comprises a VCSEL source.

Preferably, wherein said detection window comprising polypropylene.

Preferably, the electromagnetic wave being monitored is infrared.

Preferably, said light source, said optical detector and said window being arranged to form a security detection loop for monitoring tampering of said detection window, said security detection loop being interrupted when the refractive characteristics of the window are modified and an alarm signal representing tampering being generated upon detection of a change of refractive characteristics of said detection window above a threshold.

Preferably, the window is also transparent to the electromagnetic wave to be detected.

Preferably, a transparent block being disposed intermediate said detection window and said optical source, said transparent block causes said surveillance beam to incident at said detection window at above the critical angel of the detection window.

Preferably, the transparent block being adhered to said detection window by a transparent glue medium of a refractive index intermediate that of said detection window and said transparent block.

### BRIEF DESCRIPTION OF THE DRAWINGS

Preferred embodiments of the present invention will be explained in further detail below by way of example and with reference to the accompanying drawings, in which:

FIG. 1 is a schematic diagram showing a first preferred embodiment of this invention,

FIG. 1A is an enlarged view of the monitoring device of FIG. 1,

FIG. 2 is a schematic diagram illustrating a monitoring device of FIG. 1 tampered by application of an IR opaque coating on an external surface of the detection window,

FIG. 2A is an enlarged view of the optical arrangement of the monitoring device of FIG. 1 when being tampered,

FIG. 3 is a schematic diagram showing a monitoring device of a second preferred embodiment of this invention with an exemplary optical surveillance loop illustrated in arrows, and

FIG. 4 is a schematic diagram illustrating the alteration of the optical surveillance loop when the detective window is tampered by a layer of transparent lacquer.

### DETAILED DESCRIPTION OF THE PREFERRED EMBODIMENTS

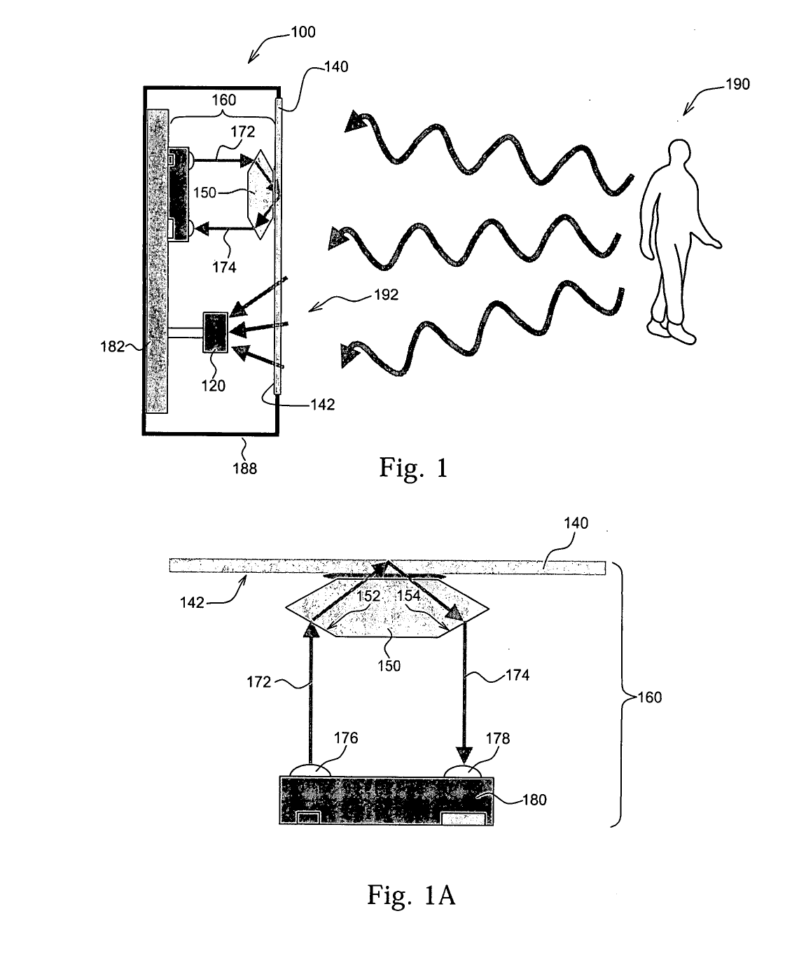

Referring firstly to the monitoring device of FIGS. 1 and 1A, the monitoring device 100 comprises an electromagnetic wave sensor 120, a detection window 140 and an anti-tampering arrangement 160. The electromagnetic wave sensor 120 is for sensing electromagnetic wave of or emanated by an external electromagnetic wave source, for example, a moving human body 190. The detection window 140 is disposed intermediate the external electromagnetic wave source and the electromagnetic wave sensor. More particularly, the detection is for forming a partition between the external electromagnetic wave source and the electromagnetic wave sensor.

The anti-tampering arrangement comprises an optical arrangement 170 for deploying an optical surveillance beam and control circuitry. More particularly, the optical arrangement is adapted for forming a closed loop optical monitoring circuit during normal surveillance operation so that intrusion will be detected if there is any noticeable disruption to the closed loop optical circuit. The optical surveillance beam comprises a first beam portion 172 and a second beam portion 174. The first beam portion is an optical beam emitted by the optical arrangement towards the detection window and the second optical beam portion is due to total internal reflection of the first beam portion by the detection window. More specifically, the optical arrangement comprises an optical source 176 which is aligned for emitting an optical surveillance beam orthogonally towards the detection window and an optical detector 178 which is aligned for detecting the surveillance beam after undergoing total internal reflection upon encountering the detection window.

To form a complete security detection loop comprising the optical surveillance beam and the optical arrangement, the detection window, at least the portion of the detection window which is involved with the optical arrangement and forming part of a security detection loop, is transparent to the optical surveillance beam. Since the second beam is a result of total internal reflection at the detection window, the refractive index of the detection window needs to be higher than that of the external space or medium which is immediately adjacent the detection window so that total internal reflection can occur at the interface between the detection window and the external space or medium. Although the external medium is air in this example, the external medium can be water for an underwater monitoring system or other fluid.

The control circuitry comprises electronic circuitry 180 for monitoring detection of the optical surveillance beam, especially the second beam portion, and for sending out an alarm signal upon detection of a variation of the second beam portion indicative of tampering of the detection window. The exemplary control circuitry of FIG. 1 is for monitoring electrical output of the optical detector. A variation in the electrical output of the optical detector will be indicative of a variation in the intensity of the detected surveillance beam. Such a variation in turn indicates tampering of the detection window since tampering of the detection window by the application of a transparent coating substance on the external surface of the detecting window will change its refractive characteristics. More specifically, the refractive gradient between the detection window and the external medium is reduced so that total internal reflection will no longer occur at the detection window when the optical surveillance beam is incident upon the detection window. As a result, the security detection loop is broken or at least interrupted. The control circuitry also comprises circuitry for controlling the operation of the optical source, for example, for setting the operating point of a laser source, in order to control the intensity or modulation of the optical surveillance beam emitted by the optical source. The control circuitry further comprises processing circuitry to process the electrical output of the optical detector in order to enable the control circuitry to compare the level of incident beam in a normal, un-tampered situation, to a level corresponding to an abnormal, tampered, situation. In the specific example, the optical arrangement and the control circuitry are mounted on a single printed circuit board (PCB) 182 and are enclosed within a housing 188 with the detection window providing interfacing between the external medium and the optical arrangement. Containing the security detection loop within an enclosure mitigates the risks of direct tampering of the security loop. More specifically, the optical arrangement is placed behind the detection window so that the detection window is intermediate an external electromagnetic wave source and the optical arrangement.

The electromagnetic wave sensor is located behind the detection window so that it can detect electromagnetic wave emanated by an external electromagnetic wave source in front of the detection window. More specifically, the electromagnetic wave sensor comprises a PIR detector for detecting infrared radiation emanating from an object. The PIR sensor is placed behind the window for monitoring an external IR source which is in a line of sight relationship with the PIR sensor. The detection window is transparent to both the optical surveillance beam and the electromagnetic wave being monitored. However, as the different portions of the detection window serve different purposes, the detection window can have a split optical characteristic. For example, the portion of the detection window which forms part of the security detection loop with the optical arrangement can be transparent to the optical surveillance beam while it could be opaque to the electromagnetic wave being monitored. On the other hand, the portion of the detection window which is opposite the PIR sensor needs to be transparent to the EM wave being monitored but could be opaque to the optical surveillance beam.

Referring to FIGS. 1 and 1A, a transparent block 150 of glass, polypropylene or other transparent materials of a high refractive index, is disposed intermediate the detection window 140 and the optical assembly comprising the optical source 176 and the optical detector 178. The transparent block 150 is deployed to facilitate a higher flexibility in the design of the geometry of the optical surveillance beam so that the distance between the optical source 176 and the optical detector 178 in the optical arrangement can be varied or designed according to actual spatial requirements. More particularly, the transparent block 150 has a polygonal (more specifically, hexagonal) cross section in a plane containing the optical surveillance beam. The polygonal transparent block is attached to the inner (or back) surface 142 of the detection window by an index matching glue so that the refractive index of the transparent block, the glue and the detection window are substantially the same. Where the refractive indexes of the detection window and the transparent block are different, the refractive index of the index matching glue is preferably intermediate that of the detection window and that of the hexagonal transparent block for a smooth refractive gradient.

The configuration of the hexagonal transparent block 150 is such that the optical surveillance beam emitted by the optical source will impinge at a first incident surface on the polygonal transparent block and refracted forwardly towards the detection window. On transiting from the transparent block to the detection window and because of the index matching glue, the optical surveillance beam proceeds along a substantially unaltered path. The relationship between the first incident surface 152 of the polygonal block and the detection window 140 is such that after refraction by the transparent block upon incidence, the optical surveillance beam will incident upon the detection window at an angle above the critical angle so that the optical surveillance beam will undergo total internal reflection before being directed back towards the optical detector. This occurs after the surveillance beam has undergone further refraction at a second incident surface 154 of the polygonal block intermediate the detection window and the optical arrangement. It will be noted that the lateral distance between the optical source and the optical detector is a function depending on the angle of incidence at the first incident surface 152, the thickness of the polygonal transparent block and the angle of incidence at the second incident surface 154.

In the specific example of FIG. 1, the optical source 176 is a laser source and the detection window is made of polypropylene which is transparent to both the laser surveillance beam and the IR radiation beam being monitored. The portion of the detection window forming part of the security detection loop is profiled with a flat surface facing the external medium. The arrangement of the optical source and the flat surface is such that the first beam portion emitted by the optical source will be incident on the flat surface of the detection window 140 at above the critical angle so that the incident optical surveillance beam will undergo total internal reflection at the detection window 140. The optical surveillance beam after undergoing total internal reflection will then incident on an adjacent sidewall 154 of the polygonal block, and is then refracted towards the optical detector 178. The portion 192 of the detection window which is opposite the PIR sensor is made as a Fresnel lens so that IR radiation from an external source is collected and focused onto the PIR detector. The optical source in this example comprises a VCSEL (Vertical-Cavity Surface-Emitter Laser) laser source as a convenient example.

During normal surveillance operation, the optical source will generate an optical surveillance beam. The optical surveillance beam is incident upon the detection window at an angle above the critical angle so that the optical surveillance beam is totally reflected and then diverted towards the optical detector, whereby a security detection loop is maintained. The control circuitry monitors the level of the optical surveillance beam being detected by the optical detector so that, upon detection of a drop of the detected optical surveillance beam below a threshold level, an alarm will be triggered. As the level of the incident optical surveillance beam will be represented by the electrical output of the optical detector, the control circuitry can, by monitoring the electrical output of the detector, monitor the variation in the level of the incoming optical surveillance beam.

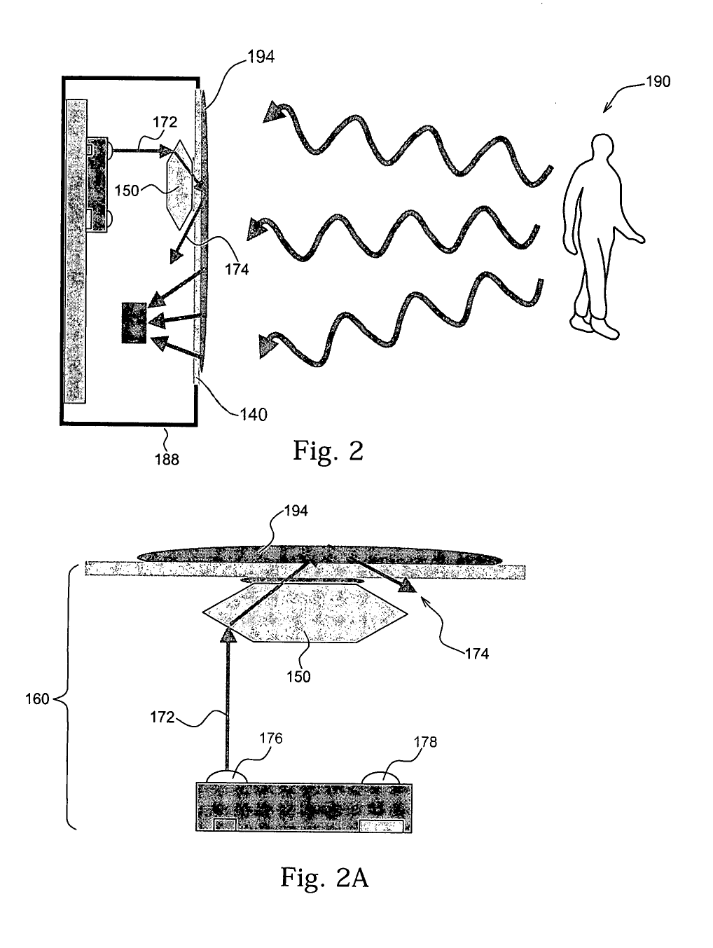

When the detection window has been tampered, as shown in FIGS. 2 & 2A, the refractive characteristics of the detection window, especially the refractive index gradient between the detection window and the external medium, are changed so that the critical angle is also changed. More particularly, when a tampering fluid has been applied onto the surface of the detection window, the surface tension of the tampering fluid will cause the tampering fluid to smoothen out and form a curved surface transparent to the optical surveillance beam upon drying. The formation of a curved transparent coating 194 on the detection window 140 will reduce the difference of refractive index between the two media (that is, the detection window 140 and air) and change the critical angle of incidence. As a result, the incident optical surveillance beam no longer impinges on the detection window at above the critical angle. Consequently, the optical surveillance beam, or a substantial portion thereof, will pass through the detection window. As a further result, the level of the optical surveillance beam being returned to the optical detector will drop below a threshold value, indicating that the detection window has been tampered. Upon detection of such a variation, the control circuitry will generate an alarm signal for further processing. A transparent lacquer is an example of a commonly used adhesive tampering fluid.

Turning now to the operation of the monitoring device 100 of FIGS. 1 and 1A, during normal operation, an optical surveillance beam is generated by the optical source of the optical arrangement. The optical surveillance beam will be refracted towards the detection window upon entering the polygonal transparent block and will travel towards the detection window. More particularly, the transparent block is disposed so that the first beam portion is deflected by refraction towards the detection window at an angle of incidence above the critical angle of the junction between the detection window and the external medium. Upon encountering the interface between the detection window and the external medium (for example, air), the optical surveillance beam after undergoing total internal reflection, is reflected back towards the second incident surface and then further refracted towards the optical detector according to a pre-designed path geometry.

When the detection window has been tampered, for example, by applying a layer of transparent lacquer coating on the external surface of the detection window, the refractive index gradient, that is, the change of refractive index when progressing from the detection window to the external window has been altered so that the critical angle is increased. As a result of the increase in the critical angel, total internal reflection will not occur at the interface or junction between the detection window and the transparent lacquer. As a result, the optical surveillance beam will progress towards the outside of the monitoring device. In the specific example of Fig. !, the optical surveillance beam impinges on the exterior surface of the transparent lacquer at above the critical angle. As a result, the optical surveillance beam is totally reflected by the tampering coating. However, because of the additional thickness of the tampering coating 194, the path of the optical surveillance beam has been altered so that the destination of the surveillance beam is outside the detection range of the optical detector. As a result, the level of incident optical surveillance beam detected by the optical detector falls below a threshold level and the control circuitry will generate an alarm signal to cause alert of possible intruders or an indication abnormality in the surrounding environment being monitored.

In the description below, parts or components which are common, identical or equivalent to that of the first preferred embodiment are designated with the same numerals plus 200.

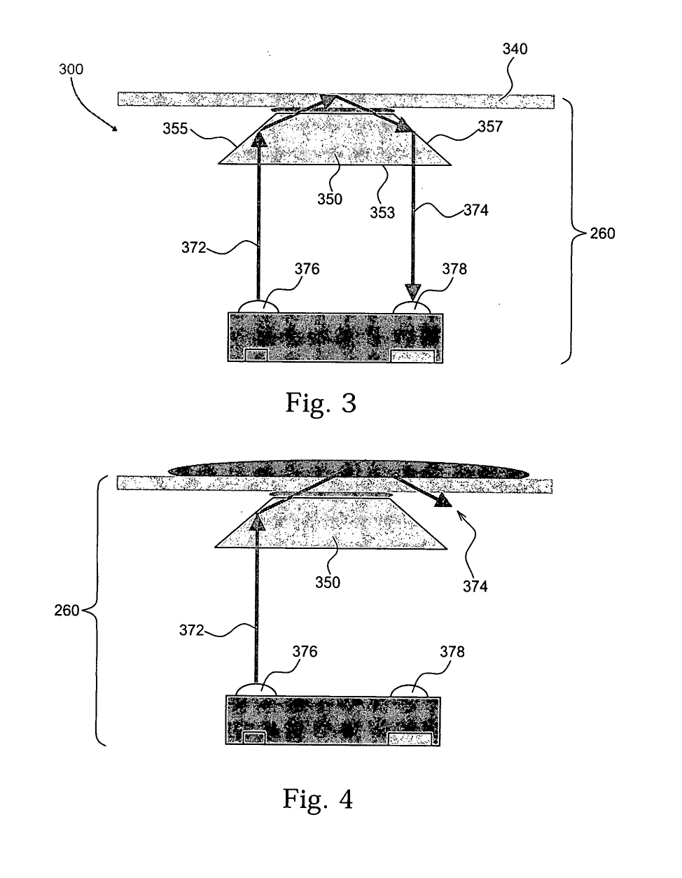

In a second preferred embodiment 300 as shown in FIGS. 3 and 4, the transparent block 350 has a polygonal cross section of a trapezium with the two parallel edges being parallel to the detection window. More particularly, the longer parallel edge 353 of the trapezium is orthogonal to the incident and emergent portions of the optical surveillance beam. In other words, the optical surveillance beam enters and leaves the transparent block orthogonally at the wider edge. As shown in FIG. 3, the incident optical surveillance beam enters the transparent block at 90° and incident upon the first slanted side 355 of the transparent block at above the critical angle and undergoes total internal reflection towards the detection window. The geometry of the transparent block and the detection window is designed so that the surveillance beam after undergoing total internal reflection will impinge on the interface between the detection window and the external medium. Consequently, the surveillance beam undergoes a further total internal reflection at the interface and travels towards the second slanted edge 357 of the transparent block at which it undergoes a further total internal reflection towards the optical detector 378 to complete the security detection loop. Although the trapezium cross-section of the transparent block is symmetrical about this centre line, it is not necessarily so and can be adjusted to vary the location of the optical detector. The arrows of FIG. 3 illustrate the paths of the optical surveillance beam during normal operation. As shown in FIG. 4, when the detection window is tampered by a transparent lacquer, total internal reflection does not occur at the interface between the detection window and the lacquer, and the optical surveillance beam will progress until encountering the interface between the transparent lacquer and the external medium. When the surveillance beam is impinging on the junction between the transparent lacquer and the external medium, it may or may not undergo total internal reflection, depending on the angle of incidence. Even if the angle of incidence at that junction exceeds the critical angle, the totally reflected surveillance beam will fall outside the detection range of the optical detector and giving rise to an alarm signal as a result of a drop in the detection of the intensity of the detected surveillance beam.

The detection surface can be curved or planar as is commonly known by persons skilled in the art.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to an intrusion detector comprising a PIR sensor, it should be appreciated that the invention can apply, whether with or without modification, to other monitoring devices with other EM-wave sensors without loss of generality.

1. A monitoring device for security surveillance application, the device comprising:
an electromagnetic wave sensor for sensing an electromagnetic wave from an external electromagnetic wave source;
a detection window disposed intermediate between said external electromagnetic wave source and said electromagnetic wave sensor; and
an anti-tampering arrangement, comprising an optical arrangement having a loop that includes an optical surveillance beam a transparent block, and said detection window, said optical arrangement comprising an optical source which is arranged to emit an optical surveillance beam which undergoes a total internal reflection at said detection window due to said transparent block, and an optical detector arranged to monitor detection of said reflected optical surveillance beam.

2. A monitoring device according to claim 1, wherein
said optical surveillance beam comprises a first beam portion and a second beam portion, said first beam portion being a beam emitted by said optical arrangement towards said detection window, and said second beam portion being due to total internal reflection of said first beam portion by said detection window,
said optical arrangement comprises a transparent block which is disposed intermediate said detection window and said optical source, and is shaped and arranged to cause said first beam portion to incident said detection window at or above a critical angle, and
said control circuitry being for detection of a variation of said second beam portion, wherein the variation is indicative of tampering of said detection window.

3. A monitoring device according to claim 2, wherein said detection window is positioned forward of said optical arrangement, said optical source being arranged for emitting said optical surveillance beam forwardly towards said detection window, and said optical detector being arranged for detecting said second beam portion of said surveillance beam after undergoing total internal reflection upon encountering said detection window; and said control circuitry is arranged to monitor electrical output of said optical detector to detect a variation in electrical output of said optical detector which corresponds to a variation in the optical refractive characteristics of said detection window and indicative of tampering of said detection window.

4. A monitoring device according to claim 2, wherein said control circuitry is arranged to monitor variation in electrical output of said optical detector to detect a variation in the refractive characteristics or refractive gradient of said detection window such that an alarm indicative of tampering of said detection window is emitted upon detection of said variation.

5. A monitoring device according to claim 4, wherein said optical source, said detection window and said optical detector are arranged such that an optical surveillance beam emitted from said optical source is diverted towards said optical detector by total internal reflection upon encountering said detection window.

6. A monitoring device according to claim 4, wherein said control circuitry comprises a control means for monitoring electrical output of said optical detector, said control means generating an alarm signal when variation in electrical output from said optical detector exceeds a predetermined threshold level.

7. A monitoring device according to claim 4, wherein said detection window is transparent to both said electromagnetic wave and said optical surveillance beam.

8. A monitoring device according to claim 3, wherein said electromagnetic wave is infrared and the electromagnetic wave sensor comprises a passive infrared sensor.

9. A monitoring device according to claim 3, wherein said optical source comprises a laser transmitter for emitting a laser surveillance beam and the optical detector comprises a photo-detector for detecting said laser surveillance beam.

10. A monitoring device according to claim 9, wherein said laser transmitter comprises a VCSEL source.

11. A monitoring device according to claim 3, wherein said detection window comprising polypropylene.

12. A monitoring device according to claim 3, wherein the electromagnetic wave being monitored is infrared.

13. A monitoring device according to claim 4, wherein said light source, said optical detector and said window being arranged to form a security detection loop for monitoring tampering of said detection window, said security detection loop being interrupted when the refractive characteristics of the window are modified and an alarm signal representing tampering being generated upon detection of a change of refractive characteristics of said detection window above a threshold.

14. A monitoring device according to claim 13, wherein the detection window is also transparent to the electromagnetic wave to be detected.

15. A monitoring device according to claim 4, wherein said transparent block is hexagonal.

16. A monitoring device according to claim 15, wherein the transparent block is adhered to said detection window by a transparent glue medium of a refractive index intermediate that of said detection window and said transparent block.

17. An intrusion detector comprising a monitoring device of claim 1.

18. An intrusion detector comprising a monitoring device of claim 2.

19. An intrusion detector comprising a monitoring device of claim 3.
